(19) United States
(12) Patent Application Publication
(10) Pub. No.: US 2020/0030967 A1
(43) Pub. Date: Jan. 30, 2020

(54) ROBOTS FOR PICKING PRODUCTS TO COMPLETE AN ORDER

(71) Applicant: NCR Corporation, Atlanta, GA (US)

(72) Inventor: John Coker Goodwin, III, Suwanee, GA (US)

(21) Appl. No.: 16/049,604

(22) Filed: Jul. 30, 2018

(51) Int. Cl. B25J 9/00; B65G 47/52

(52) U.S. Cl. CPC B25J 9/0093; B65G 47/52

(57) ABSTRACT

Disclosed are systems and methods for picking a product to complete an order. The systems and methods may include receiving product information obtained via a user mobile device; retrieving, by a robot, the product from the location within the warehouse; and depositing, by the robot, the product in a bin assigned to an order. The product information may identify a location of the product in a warehouse.

### SUMMARY

Disclosed are systems and methods for picking a product to complete an order. The systems and methods may include receiving product information obtained via a user mobile device; retrieving, by a robot, the product from the location within the warehouse; and depositing, by the robot, the product in a bin assigned to an order. The product information may identify a location of the product in a warehouse.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows an example schematic of an environment for picking products to complete an order consistent with this disclosure.

FIG. 2 shows an example schematic of robot consistent with this disclosure.

FIG. 3 shows an example method consistent with this disclosure.

FIG. 4 shows an example schematic of a central computer consistent with this disclosure.

FIG. 5 shows an example method consistent with this disclosure.

Corresponding reference characters indicate corresponding parts throughout the several views. The exemplifications set out herein illustrate exemplary embodiments of the invention, and such exemplifications are not to be construed as limiting the scope of the invention any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the disclosed systems. Accordingly, the following detailed description does not limit this disclosure. Instead, the proper scope of any invention disclosed herein is defined by the appended claims.

As disclosed herein, robots may be used to pick products that customers have ordered and deliver the picked and paid for products to a staging area for the customer to retrieve. In addition, the robots may deliver the picked products to a checkout area where the customers may retrieve and pay for the ordered products as well as pay for products the customer may have selected while in the store.

As disclosed herein, the customers may order the products online, via their handheld mobile devices, or kiosk located within a retail environment (i.e., a brink and mortar store). For example, as disclose herein, customers may order products while at home using their desktop or laptop computers as well as their tables, cellphones, or other handheld computing devices. The customer may also order products while in a store using their tables, cellphones, or other handheld computing devices or a kiosk located within the store. The items may display items on a shelf and the actual inventory kept in a stockroom, sometimes interchangeably referred to as a warehouse.

Once the products are ordered, a robot may retrieve the products. For example, the robots may receive product information for each of the ordered products. The product information may include a DIGIMARC® code, quick reference (QR) code, a traditional barcode, a reference image of the packaging for the product, an image of the product itself, etc. The robot may then travel throughout the warehouse to where the products are supposed to be stored. Once there, the robot may scan the products on the shelf to identify the products. Once the products are identified the robot may use a picker to pick the items from the shelf and place them in a bin assigned to an order. The bin may be a bin attached to the robot or a bin assigned to the order and located in a staging area.

As an example, the robot may scan a DIGIMARC® code, which is a code printed over the entire packaging of the product in an ink that is only visible to the robot, to identify the product. The ink may be visible in the infrared or ultraviolent spectrums of light, but not the visible spectrum visible to humans. When scanning the products, the robot may compare the scanned code or captured image of the product to known image or know code to confirm that the product is the correct product. The known image or code may be stored within a memory of the robot. In some embodiments the code on the package may act as a pointer to allow the robot to retrieve a known image or code of the product for comparison. In various embodiments, the robot may simply compare data extracted from the code or image to data stored in a database, either in the robot's memory or a remote computing location, to determine that the picked product is the ordered product. The use of a code, such as the DIGIMARC® code, is useful because it can be printed over the entire packaging. As such, the code will be visible to the robot regardless of the orientation of the product. This differs from traditional barcodes that are print in inconspicuous locations so as not to obscure the packaging.

The robot may pick items for multiple orders at one time. For example, the robot may pick a first product for a first order and may pick a second product for a second order. The first product and the second product may be in close proximity to one another. For instance, the first product and the second product may be on the same or adjacent shelves within the warehouse. The first product and the second product may be the same product. For example, two separate customers may order the same product. As a result, when the robot is picking the product for the first customer the robot may pick two of the product for each customer.

Once the robot has determined it has picked the correct product, the robot may transport the product to a bin assigned to the order. If the robot has multiple products for the same customer, the robot may place the products in a bin assigned to the customer's order. If the robot has products for multiple customers, the robot may place each product for a specific order in a bin assigned to the respective orders. The bins may be attached to the robot or the bins may be located in a staging area or other pickup area for the customer to retrieve and/or pay for the products.

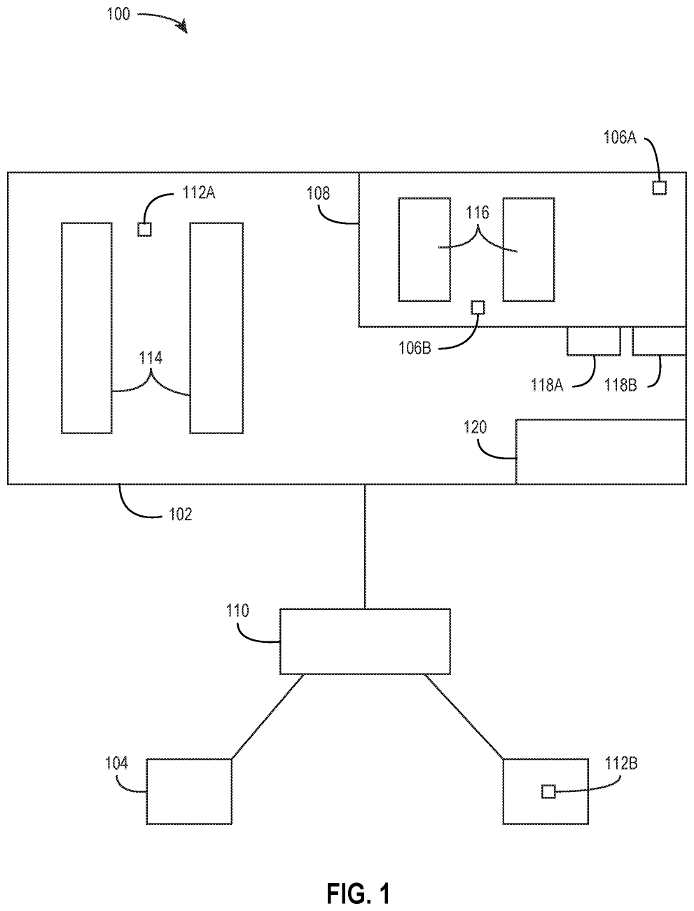

Turning now to the figures, FIG. 1 shows an example schematic of an environment 100 for picking products to complete an order consistent with this disclosure. As shown in FIG. 1, environment 100 may include a store 102, a central computer 104, and robots 106 (individually, robot 106A and robot 106B). Robots 106 may be located in a warehouse 108 of store 102 and may communicate with central computer 104 via a network 110. Warehouse 108 may be attached to or otherwise associated with store 102.

Customers 112 (individually customer 112A and customer 112B) may use mobile devices to communicate with central computer 104 via network 110. Customers 112 may be in store 102 and select products from shelves 114 or at home or some other location not associated with store 102. As a result, customers 112 may order products from store 102 or other locations. Because warehouse 108 may be attached to or located within store 102, shelves 114 may not need to be stocked with a full inventory of products, thus, shelves 114 may be smaller than usual. As shoppers 112 walk through store 102, they may order products that are picked from warehouse 108 as disclosed herein. Once the products are picked, shoppers 112 may retrieve the products from bins 118.

Once the products are ordered, central computer 104 may transmit product information to one or more of robots 106. In addition, to product information, central computer 104 also may transmit a travel path to robots 106. For instance, central computing device 104 may use a location of robots 106, which may constantly update central computer 104 with their location, and a location of products on shelves 116 to determine a shortest travel path using statistical methods, Monte Carlo methods, or other preplanned travel paths and may transmit the travel path to robots 106. In addition, robots 106 also may determine travel paths. For example, robots 106 may know their location within warehouse 108 and may include data indicating where various products are located within warehouse 108. As a result, when robots 106 receive an order they may use their current location and the locations of the various products to determine the shortest travel path to retrieve the various products in the orders.

Once the products are picked, robots 106 may deposit the products in bins 118 (individually bin 118A and bin 118B). As disclosed herein, robots 106 may place multiple products in a single bin, such as bin 118A, that are for a given order. A single robot, such as robot 106A, may place products in one of both of bins 118. For example, if robot 106A picks products for multiple products for two separate orders in a single trip through warehouse 108, robot 106A may deposit products for the first order in bin 118A and products for the second order in bin 118B.

Once the products are in bins 118, the customers may retrieve the products and pay for any unpaid products at a checkout area 120. An employee of the store may also assist the customers with retrieving and/or paying for their products at checkout area 120.

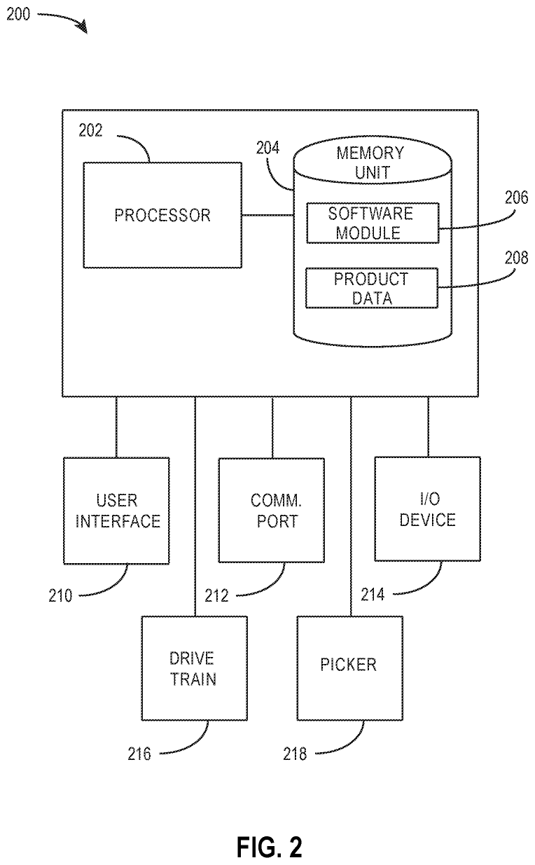

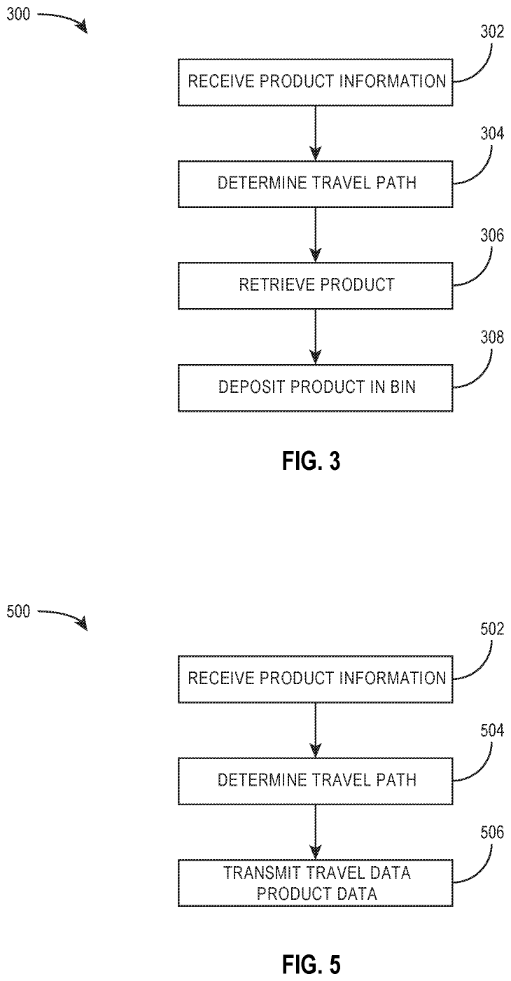

FIG. 2 shows an example schematic of a robot, such as robot 106A or robot 106B, consistent with embodiments disclosed herein. As shown in FIG. 2, robot 200 may include a processor 202 and a memory 204. Memory 204 may include a software module 206 and product data 208. While executing on processor 202, software module 204 may perform processes for picking products, including, for example, one or more stages included in a method 300 described below with respect to FIG. 3. Robot 200 may also include a user interface 210, a communications port 212, an input/output (I/O) device 214, a drive train 216, and a picker 218.

As disclosed herein, product data 208 may include data regarding the various products located within a store, such as store 102. For example, product data 208 may include the locations of products within warehouse 108, which particular shelf of shelves 116 the various products are located, travel times from various locations within warehouse 108 to retrieve the various products, etc. Product data 208 also may include identification data for the products. For example, the identification data may include images of the products, codes, such as barcodes, that can be used to identify the products.

User interface 210 can include any number of devices that allow a user to interface with robot 200. Non-limiting examples of user interface 210 include a keypad, a microphone, a display (touchscreen or otherwise), etc.

Communications port 212 may allow robot 200 to communicate with various information sources and devices, such as, but not limited to, remote computing devices, such as central computer 104, mobile devices, peripheral devices, etc. Non-limiting examples of communications port 212 include, Ethernet cards (wireless or wired), Bluetooth® transmitters and receivers, near-field communications modules, etc.

I/O device 214 may allow robot 200 to receive and output information. Non-limiting examples of I/O device 214 include, a camera (still or video), a weight detection device such as a scale, a printer for print receipts and packing lists, a scanner, etc.

Drive train 216 may allow robot 200 to traverse within warehouse 108 so that robot 200 may travel to products and bins 118. Non-limiting examples of drive train 216 include wheels, tracks, etc. During operation, processor 202 may transmit activation signals that activate drive train 216.

Picker 218 may allow robot 200 to actually pick up products from shelves and place the products in bins. Non-limiting examples picker 218 include robotic arms, vacuum mechanics that can pick up products, etc. During operation, processor 202 may transmit retrieval signals that active picker 218 and cause picker 218 to pick products from shelves.

FIG. 3 shows method 300 for picking products to complete an order consistent with this disclosure. Method 300 may begin at stage 302 where product information may be received by a robot, such as robot 200. The product information may be received from a remote computer such as central computer 104.

From stage 302 method 300 may proceed to stage 304 where a travel path may be determined. For example, as disclosed herein, the travel path may be determined using product data, such as product data 208 to determine a travel path, such as the shortest travel path, so that the robot can retrieve the product and travel to a bin.

From stage 304 method 300 may proceed to stage 306 where the product may be retrieved. As disclosed herein, processor 202 may transmit an activation signal to drive train 216 so as to cause robot 200 to travel to the product. Once at the product, I/O device 214 may be used to scan the product. As disclosed herein, I/O device 214 may scan codes or capture images of the product and processor 202 may use the code or image to verify the product is the ordered product. For example, using images, processor 202 may perform image analysis on the images using the captured images and known reference images of the product to verify the product. The processor 202 may also use the code to verify the product by verifying that the product scanned by I/O device 214 is the code associated with the product. Retrieving the product may include retrieving one or more products and multiple products may be retrieved for multiple orders as disclosed herein.

From stage 306 method 300 may proceed to stage 308 where the product may be deposited in a bin. For example, as disclosed herein, the robot 200 may transport the products to bins 118 so that customers can retrieve the products.

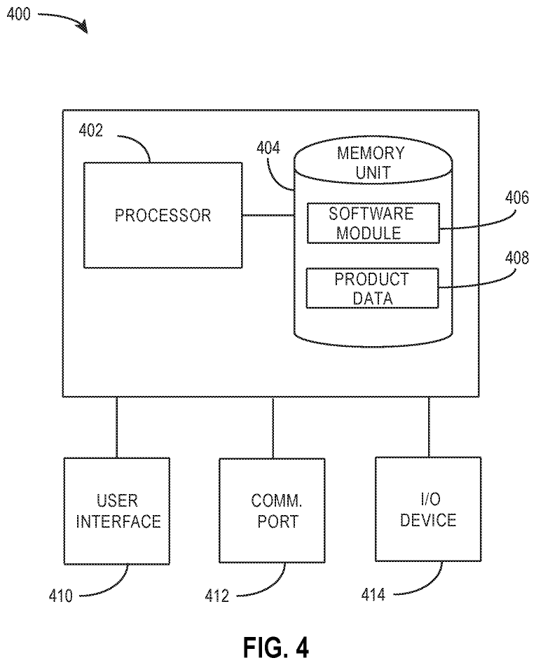

FIG. 4 shows an example schematic of a central computer 400, such as central computer 104, consistent with embodiments disclosed herein. As shown in FIG. 4, central computer 400 may include a processor 402 and a memory 404. Memory 404 may include a software module 406 and product data 408. While executing on processor 402, software module 404 may perform processes for picking products, including, for example, one or more stages included in a method 500 described below with respect to FIG. 5. Central computer 400 may also include a user interface 410, a communications port 412, and an input/output (I/O) device 414.

As disclosed herein, product data 408 may include data regarding the various products located within a store, such as store 102. For example, product data 408 may include the locations of products within warehouse 108, which particular shelf of shelves 116 the various products are located, travel times from various locations within warehouse 108 to retrieve the various products, etc. Product data 408 also may include identification data for the products. For example, the identification data may include images of the products, codes, such as barcodes, that can be used to identify the products.

User interface 410 can include any number of devices that allow a user to interface with central computer 400. Non-limiting examples of user interface 410 include a keypad, a microphone, a display (touchscreen or otherwise), etc.

Communications port 412 may allow central computer 400 to communicate with various information sources and devices, such as, but not limited to, remote computing devices, such as mobile devices operated by shoppers, robots, such as robot 200, peripheral devices, etc. Non-limiting examples of communications port 412 include, Ethernet cards (wireless or wired), Bluetooth® transmitters and receivers, near-field communications modules, etc.

I/O device 414 may allow central computer 400 to receive and output information. Non-limiting examples of I/O device 414 include, a camera (still or video), a printer for print receipts and packing lists, a scanner, etc.

Central computer 400 may be located within a store, such as store 102. Central computer 400 also may be located at a located remote location. For example, central computer 400 may be located at a data center or corporate headquarters, etc. and may transmit information to and from robots via a network, such as network 110.

FIG. 5 shows method 500 for picking products to complete an order consistent with this disclosure. Method 500 may begin at stage 502 where product information may be received by a central computer, such as central computer 400. The product information may be received from a mobile device of a shopper or from a robot such as robot 200. The product information may include codes, images, etc. as disclosed herein.

From stage 502 method 500 may proceed to stage 504 where a travel path may be determined. For example, as disclosed herein, the travel path may be determined using product data, such as product data 408 to determine a travel path, such as the shortest travel path, so that the robot can retrieve the product and travel to a bin.

From stage 504 method 500 may proceed to stage 506 where the travel path and the product data may be transmitted to a robot so that the product can be picked by the robot as disclosed herein.

### EXAMPLES

Example 1 is a method of picking a product to complete an order, the method comprising: receiving, at a robot, product information obtained via a user mobile device, the product information identifying a location of the product in a warehouse; retrieving, by the robot, the product from the location within the warehouse; and depositing, by the robot, the product in a bin assigned to an order.

In Example 2, the subject matter of Example 1 optionally includes wherein the user mobile device is one of a plurality of user mobile devices and receiving product information includes receiving product information obtained via the plurality of mobile devices.

In Example 3, the subject matter of any one or more of Examples 1-2 optionally include wherein the product is one of a plurality of products and retrieving the product includes retrieving the plurality of products.

In Example 4, the subject matter of Example 3 optionally includes wherein retrieving the plurality of products includes retrieving the plurality of products in a single trip.

In Example 5, the subject matter of any one or more of Examples 3-4 optionally include determining a shortest travel path for retrieving the plurality of products.

In Example 6, the subject matter of any one or more of Examples 3-5 optionally include wherein a first subset of the plurality of products are for a first order and a second subset of the plurality of products are for a second order.

In Example 7, the subject matter of any one or more of Examples 1-6 optionally include determining a travel path for retrieving the product.

In Example 8, the subject matter of any one or more of Examples 1-7 optionally include receiving a travel path for retrieving the product.

In Example 9, the subject matter of any one or more of Examples 1-8 optionally include wherein retrieving the product comprises scanning a code imprinted on a package of the product, the code visible in an infrared spectrum and not visible by a human eye.

In Example 10, the subject matter of any one or more of Examples 1-9 optionally include wherein depositing the product in a bin assigned to an order includes depositing the product in one of a plurality of bins associated with the robot.

In Example 11, the subject matter of any one or more of Examples 1-10 optionally include wherein depositing the product in a bin assigned to an order includes depositing the product in one of a plurality of bins, the one of the plurality of bins associated with the order.

Example 12 is a robot for picking a product to complete an order, the robot comprising: a picker; a drive train; a processor in electrical communication with the picker and the drive train; and a memory storing instructions that, when executed by the processor, cause the processor to: receive product information obtained via a user mobile device, the product information identifying a location of the product in a warehouse, transmit navigation signal to the drive train, the navigation signal including data defining a navigation path through the warehouse to the product, scan product, and transmit retrieval signal to the picker, the retrieval signal configured to cause the picker to pick up the product and deposit the product in a bin assigned to an order.

In Example 13, the subject matter of Example 12 optionally includes wherein the user mobile device is one of a plurality of user mobile devices and receiving product information includes receiving product information obtained via the plurality of mobile devices.

In Example 14, the subject matter of any one or more of Examples 12-13 optionally include wherein the product is one of a plurality of products and the retrieval signal is further configured to cause the picker to pick up the plurality of products and deposit the plurality of products in the bin assigned to the order.

In Example 15, the subject matter of Example 14 optionally includes wherein the plurality of products picked up and deposited in the bin assigned to the order in a single trip.

In Example 16, the subject matter of any one or more of Examples 14-15 optionally include wherein the instructions, when executed by the processor, further cause the processor to determine a shortest travel path for picking up and depositing the plurality of products.

In Example 17, the subject matter of any one or more of Examples 14-16 optionally include wherein a first subset of the plurality of products are for a first order and a second subset of the plurality of products are for a second order.

In Example 18, the subject matter of any one or more of Examples 12-17 optionally include wherein the instructions, when executed by the processor, further cause the processor to determine a travel path for picking up and depositing the product.

In Example 19, the subject matter of any one or more of Examples 12-18 optionally include wherein the instructions, when executed by the processor, further cause the processor to receive a travel path for picking up and depositing the product.

In Example 20, the subject matter of any one or more of Examples 12-19 optionally include a camera and wherein the instructions, when executed by the processor, further cause the processor to receive, from the camera an image of a code imprinted on a package of the product, the image visible to the camera and not visible by a human eye.

In Example 21, the subject matter of any one or more of Examples 12-20 optionally include wherein the retrieval signal configured to deposit the product in a bin assigned to an order includes the retrieval signal configured to deposit the product in one of a plurality of bins associated with the robot.

In Example 22, the subject matter of any one or more of Examples 12-21 optionally include wherein the retrieval signal configured to deposit the product in a bin assigned to an order includes the retrieval signal configured to deposit the product in one of a plurality of bins associated with the order.

Example 23 is a method of picking a plurality of products to complete an order, the method comprising: receiving, at a central computer comprising a processor, product information from a plurality of mobile devices, each of the plurality of mobile devices associated with one of a plurality of users, the product information obtained from a scanned image; determining, by the central computer, a travel path for a robot to traverse within a warehouse to retrieve each of the plurality of products; and transmitting, by the central computer, the product information and the travel path to the robot.

In Example 24, the subject matter of Example 23 optionally includes wherein the travel path allows for the plurality of products to be retrieved in a single trip.

In Example 25, the subject matter of any one or more of Examples 23-24 optionally include wherein determining the travel path further comprises determining a shortest travel path for the robot to traverse within the warehouse to retrieve each of the plurality of products.

In Example 26, the subject matter of any one or more of Examples 23-25 optionally include assigning a bin to one of a plurality of orders, the order being one of the plurality of orders.

In Example 27, the subject matter of any one or more of Examples 23-26 optionally include wherein a first subset of the plurality of products are for the order and a second subset of the plurality of products are for a second order.

In Example 28, the subject matter of any one or more of Examples 23-27 optionally include wherein receiving the product information further comprises: retrieving a control image for at least one of the plurality of products; receiving a package image for at least one of the plurality of products; and determining that the control image matches the package image via image analysis.

Example 29 is a system for picking a product to complete an order, the system comprising: a processor; and a memory storing instructions that, when executed by the processor, cause the processor to: receive, from a plurality of mobile devices, product information, each of the plurality of mobile devices associated with one of a plurality of users, the product information obtained from a scanned image; determine a travel path for a robot to traverse within a warehouse to retrieve each of the plurality of products; and transmit the product information and the travel path to the robot.

In Example 30, the subject matter of Example 29 optionally includes wherein the travel path allows for the plurality of products to be retrieved in a single trip.

In Example 31, the subject matter of any one or more of Examples 29-30 optionally include wherein determining the travel path comprises further instructions that, when executed by the processor, further cause the processor to determine a shortest travel path for the robot to traverse within the warehouse to retrieve each of the plurality of products.

In Example 32, the subject matter of any one or more of Examples 29-31 optionally include further instructions that, when executed by the processor, further cause the processor to assign a bin to one of a plurality of orders, the order being one of the plurality of orders.

In Example 33, the subject matter of any one or more of Examples 29-32 optionally include wherein a first subset of the plurality of products are for the order and a second subset of the plurality of products are for a second order.

In Example 34, the subject matter of any one or more of Examples 29-33 optionally include wherein receiving the product information comprises further instructions that, when executed by the processor, further cause the processor to: retrieve a control image for at least one of the plurality of products; receive a package image for at least one of the plurality of products; and determine that the control image matches the package image via image analysis.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

Claimed is:

1. A method of picking a product to complete an order, the method comprising:
receiving, at a robot, product information obtained via a user mobile device, the product information identifying a location of the product in a warehouse;
retrieving, by the robot, the product from the location within the warehouse; and
depositing, by the robot, the product in a bin assigned to an order.

2. The method of claim 1, wherein the user mobile device is one of a plurality of user mobile devices and receiving product information includes receiving product information obtained via the plurality of mobile devices.

3. The method of claim 1, wherein the product is one of a plurality of products and retrieving the product includes retrieving the plurality of products.

4. The method of claim 3, wherein retrieving the plurality of products includes retrieving the plurality of products in a single trip.

5. The method of claim 3, further comprising determining a shortest travel path for retrieving the plurality of products.

6. The method of claim 3, wherein a first subset of the plurality of products are for a first order and a second subset of the plurality of products are for a second order.

7. The method of claim 1, further comprising determining a travel path for retrieving the product.

8. The method of claim 1, further comprising receiving a travel path for retrieving the product.

9. The method of claim 1, wherein retrieving the product comprises scanning a code imprinted on a package of the product, the code visible in an infrared spectrum and not visible by a human eye.

10. The method of claim 1, wherein depositing the product in a bin assigned to an order includes depositing the product in one of a plurality of bins associated with the robot.

11. The method of claim 1, wherein depositing the product in a bin assigned to an order includes depositing the product in one of a plurality of bins, the one of the plurality of bins associated with the order.

12. A robot for picking a product to complete an order, the robot comprising:
a picker;
a drive train;
a processor in electrical communication with the picker and the drive train; and
a memory storing instructions that, when executed by the processor, cause the processor to:
receive product information obtained via a user mobile device, the product information identifying a location of the product in a warehouse,
transmit navigation signal to the drive train, the navigation signal including data defining a navigation path through the warehouse to the product,
transmit retrieval signal to the picker, the retrieval signal configured to cause the picker to pick up the product and deposit the product in a bin assigned to an order.

13. The robot of claim 12, wherein the product is one of a plurality of products and the retrieval signal is further configured to cause the picker to pick up the plurality of products and deposit the plurality of products in the bin assigned to the order.

14. The robot of claim 12, further comprising a camera and wherein the instructions, when executed by the processor, further cause the processor to receive, from the camera an image of a code imprinted on a package of the product, the image visible to the camera and not visible by a human eye.

15. A method of picking a plurality of products to complete an order, the method comprising:
receiving, at a central computer comprising a processor, product information from a plurality of mobile devices, each of the plurality of mobile devices associated with one of a plurality of users, the product information obtained from a scanned image;
determining, by the central computer, a travel path for a robot to traverse within a warehouse to retrieve each of the plurality of products; and
transmitting, by the central computer, the product information and the travel path to the robot.

16. The method of claim 15, wherein the travel path allows for the plurality of products to be retrieved in a single trip.

17. The method of claim 15, further comprising determining a shortest travel path for the robot to traverse with the warehouse to retrieve each of the plurality of products.

18. The method of claim 15, further comprising assigning a bin to one of a plurality of orders, the order being one of the plurality of orders.

19. The method of claim 15, wherein a first subset of the plurality of products are for the order and a second subset of the plurality of products are for a second order.

20. The method of claim 15, further comprising:
retrieving a control image for at least one of the plurality of products;
receiving a package image for at least one of the plurality of products; and
determining that the control image matches the package image via image analysis.
